(19) United States
(12) Patent Application Publication
(10) Pub. No.: US 2025/0316898 A1
(43) Pub. Date: Oct. 9, 2025

(54) DIELECTRIC DOME LENSES FOR PHASED ARRAYS

(71) Applicant: Lockheed Martin Corporation, Bethesda, MD (US)

(72) Inventors: Thomas Henry Hand, Highlands Ranch, CO (US); Carlos James Romero, Littleton, CO (US); Jason Moon, Aurora, CO (US); Erik Lier, Phoenixville, PA (US); Thomas Patrick Cencich, Littleton, CO (US); Sean F. Indman, San Jose, CA (US); Daniel Lloyd Reigh, II, Highlands Ranch, CO (US); James L. Lovejoy, Colorado Springs, CO (US)

(21) Appl. No.: 19/169,560

(22) Filed: Apr. 3, 2025

Related U.S. Application Data
(60) Provisional application No. 63/574,455, filed on Apr. 4, 2024.

(51) Int. Cl. H01Q 3/26; H01Q 15/08

(52) U.S. Cl. CPC H01Q 3/2658; H01Q 15/08

(57) ABSTRACT

Provided herein are various enhancements for electronically scanned arrays (ESAs) and performance thereof. In an example implementation, an apparatus is provided that includes an ESA and a dielectric lens applied to the ESA. The dielectric lens includes a domed arrangement formed from dielectric material. The dielectric lens advantageously allows beam scan operations performed by the ESA across a directional range to achieve a target performance over a target bandwidth.

### RELATED APPLICATIONS

This application hereby claims the benefit and priority to U.S. Provisional Application No. 63/574,455, titled “LOW-PROFILE, WIDE BAND, WIDE SCAN, DIELECTRIC DOME LENSES FOR PHASED ARRAYS,” filed Apr. 4, 2024, which is hereby incorporated by reference in its entirety.

### TECHNICAL BACKGROUND

Conventional planar arrays, such as active electronically scanned arrays (ESAs), suffer from scan loss, where the aperture gain decreases with increasing scan angle from the boresight direction due in part to the reduction in effective area at wide scan angles. This can force active ESA designs to oversize the aperture to meet performance requirements at the most extreme scan angles, where scan loss is at a maximum and aperture efficiency is at a minimum. As a result, ESAs can be oversized to address worst-case conditions at maximum scan angles. Since array size, weight, power and cost are related to aperture size, then additional costs are incurred due to the need to oversize the aperture.

### SUMMARY

The descriptions disclosed herein provide enhanced systems, apparatuses, and methods of manufacturing for dielectric dome lenses for active electronically steered array (ESA) assemblies. Specifically, the examples herein provide for an assembly including an ESA and a dielectric lens applied to the ESA to improve performance of the ESA across a directional range and over a target bandwidth. The dielectric lens includes a convex domed arrangement and is made of dielectric material that provides impedance matching capabilities with respect to ESA operations.

In an example implementation, an apparatus that includes an ESA and a dielectric lens is provided. The dielectric lens includes a domed arrangement formed from dielectric material and is applied to the ESA.

In another example implementation, a dielectric lens is provided. The dielectric lens includes a dielectric material, and a domed arrangement formed from the dielectric material. The dielectric material is configured to provide impedance matching for an electronically scanned array such that beam scan operations performed by the electronically scanned array across a directional range achieve a target performance over a target bandwidth.

In yet another example implementation, a method of manufacturing an assembly is provided. The method includes forming, from a dielectric material, a dielectric lens with a domed arrangement, and applying the dielectric lens to an electronically scanned array.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an exemplary dielectric lens in an implementation.

FIG. 2 illustrates a method of manufacturing an assembly in an implementation.

FIG. 3 illustrates an exemplary aspect of the effect of a dielectric lens applied to an array with respect to a capture area in an implementation.

FIG. 4 illustrates an exemplary aspect of the effect of a dielectric lens applied to an array with respect to a capture area in an implementation.

FIG. 5 illustrates an exemplary aspect of a dielectric lens in an implementation.

FIG. 6 illustrates exemplary aspects of dielectric lenses in an implementation.

FIG. 7 illustrates exemplary aspects of dielectric lenses in an implementation.

FIG. 8 illustrates exemplary aspects of dielectric lenses in an implementation.

FIG. 9 illustrates exemplary aspects of a dielectric lens with impedance matching holes and features of the impedance matching holes in an implementation.

FIG. 10 illustrates an exemplary graphical representation of array performance in an implementation.

FIG. 11 illustrates an exemplary graphical representation of array performance in an implementation.

### DETAILED DESCRIPTION

Technology is disclosed herein that mitigates the problems discussed above with respect to electronically scanned array (ESA) size, weight, power and cost and operational performance by employing a dielectric lens having a domed arrangement of a shape, size, and dielectric material composition that can effectuate improved performance of an active ESA across a range of directions and over a target bandwidth when applied to the ESA.

Dielectric lenses can be employed as shaped dielectrics that refract active electronically scanned array (ESA) energy to affect gain at wide scan angles by reducing scan loss and provide wider coverage with reduced ESA scan using beam deflection or beam scan magnification. Beam scan magnification refers to where an ESA is steered to some nominal scan angle X, and then the apparent far-field beam appears at some multiplier A*X, where A>1. Thus, for an application requiring a 60° conical scan and A=2, the ESA would only need to scan to 30°, thus, this would permit increasing the ESA element pitch by 20% and reducing size, weight, power and cost by 20%. Some dielectric lenses, however, target a narrow-band application, such as within the Ka band, and increase gain at wide scan angles at the expense of reduced gain at boresight and small angles. This means enhanced gain is not realized across a wide range of scan angles with some dielectric dome lenses. The examples herein instead are extensible to multiple octaves of bandwidth. When employed for frequencies from, for example, approximately 3.65-12 GHz, gain enhancement is established across a wide swath of scan angles, not just out at 60°. Thus, the enhanced dielectric lenses discussed herein improve gain performance across a swath of an antenna field of view.

Active ESAs provide mission capability for transmission and reception of RF signaling, often in a generally compact, low-profile, planar arrangement for direct radiating array (DRA) configurations. However, ESAs can represent a large fraction of the total payload cost for devices like orbital satellites. The most impactful variable in ESA cost is aperture size, usually expressed in m² or # of subarrays and can be driven by total part count. The selected application or mission can drive a minimum aperture size (to achieve a minimum gain), and thus apertures are typically sized to meet gain at the most extreme scan angles (e.g., line of sight to the edge of Earth). For orbital applications, the gain variation is most extreme at low orbits (e.g., low-earth orbit (LEO)). Thus, an ESA area is typically sized to be large enough to overcome beam scan loss and efficiency reduction (typically >>3 dB) to close at the most extreme scan.

The various dielectric lenses discussed herein can provide several advantages for ESAs. These advantages include mitigating scan loss across field of view (FOV), dielectric lenses provide a height increase for an increase in an “effective” area of the planar ESA and enable further size, weight, power, and cost reduction via aperture dilation. Thus, the dielectric lenses herein can drive ESA size/part/cost reduction but also preserve gain across the scan volume. The approaches herein apply to both wideband and narrowband applications, and wide scan and narrow scan applications, as well as overcome scan loss limitations (the gain drop over scan) by increasing the effective area of the aperture across the entire array field of view.

In some examples, when operating in a low frequency band, such as 0.3-4 GHz, the lens arrangements herein enable a 36 subarray ESA to perform equivalently to an 88 subarray DRA ESA. This may reduce active ESA weight and power by ˜400 lbs and ˜100 Watts (W), respectively, while also reducing costs for a given array size (e.g., 2.0m2 active ESA). In one example, a low-band lens is formed using syntactic foam or other low-density foam/dielectric. When operating at mid-band frequencies, such as 3.65-12 GHz, a mid-band lens can enable a 16 subarray AESA to perform equivalently to 32 subarray ESA, while reducing array weight and power by ˜100 lbs and 425 W, respectively. Mid-band lenses can be formed using machined cross-linked polystyrene or thermoset polystyrene (e.g., Rexolite) having Dk˜2.5 or similar for corresponding frequency ranges, or other qualified material. Other example materials include syntactic foams or 3D printed materials, such as Radix printable dielectric materials having ceramic-filled UV-curable polymers.

Additional advantages realized by the disclosed lens approaches include reduced height profile and mass compared to prior designs. For example, multiple octaves of instantaneous bandwidth can be achieved using tapered impedance matching holes in dielectric lenses. High total efficiency can be achieved by reduction of mismatch loss through periodic, tapered, constant-depth slots milled into the dielectric surfaces of the dielectric lenses.

The dielectric lenses discussed herein can be employed in various applications and locations, such as terrestrial, orbital, airborne, and other applications. For example, one example application includes an orbital or space environment for wideband remote sensing, among various radio frequency (RF) transmit or receive applications. Additionally, the approaches herein are compatible with different dielectric lens materials, from machinable materials such as polystyrene materials, to 3D-printable materials such as syntactic foam, which enables the dielectric lens to be scaled to larger sizes (>1 meter diameter) while keeping the total mass to a reasonable level.

The examples herein can include various systems, apparatuses, assemblies, antenna arrays, antenna structures, methods of manufacturing, or other methods. In one example, an apparatus includes an ESA, and a dielectric lens applied to the electronically scanned array. The dielectric lens can include a convex domed arrangement formed from dielectric material, which may be configured to provide impedance matching over a selected frequency range. Alternatively, the dielectric lens can include a ring, torus, or donut-shaped arrangement formed from dielectric material such that the dielectric material affects at least some off-boresight directional angles in operation of the ESA. In applying the dielectric lens to the ESA, beam scan operations of the ESA across a directional range achieve a target performance over a target bandwidth. The target performance may include a selected efficiency among a plurality of antenna elements of the ESA.

In a first example implementation, a dielectric lens includes the dielectric material having a ‘high’ dielectric constant (Dk˜4.0 or greater) laminate impedance matching layer applied to at least one surface. In a second example implementation, the dielectric lens includes a dielectric material having an array of impedance matching holes formed therein. In a third example implementation, the impedance matching holes include holes formed through a thickness of the dielectric lens, the holes including tapered ends abutting a cylindrical hole through the dielectric material. In a fourth example implementation, the dielectric material is selected from at least one among syntactic foam, cross-linked polystyrene, thermoset polystyrene, and ceramic-filled 3D printing resin. In a fifth example implementation, absorber materials are included and positioned in parallel with the electronically scanned array and disposed between one or more outer edges of the electronically scanned array and the dielectric lens.

A diameter of the dielectric lens can vary based on frequency and application, such that the diameter covers an extent of affected RF transmit/receive antenna elements of a corresponding ESA. The height and thickness of the dielectric lens can vary based on frequency and application, and can be empirically tuned to match performance targets, such as bandwidth, scan angle, weight, impedance, losses, and other considerations.

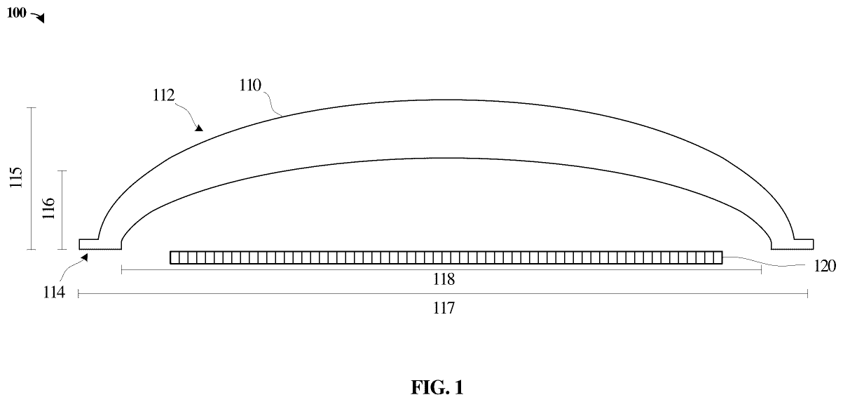

FIG. 1 illustrates an exemplary dielectric lens in an implementation. FIG. 1 shows aspect 100, which includes a side view of an assembly including dielectric lens 110 and electronically scanned array (ESA) 120.

In various implementations, ESA 120 is representative of an actively scanned phased array antenna assembly including a plurality of antenna elements by which ESA 220 can generate or receive electromagnetic waves for wireless signal transmission and reception. In a transmit mode, ESA 120 emits beams of electromagnetic energy within a frequency range using active focusing of the array across selected scan angles. In a receive mode, ESA 120 receives electromagnetic signals within a frequency range using this active focusing of the array across selected scan angles. Each of the antenna elements of ESA 120 can be electronically steered (e.g., by an RF system that provides/receives signals to/from the antenna elements) such as to shape the beams produced by the antenna elements in various directions and across several frequency ranges.

ESA 120 may exhibit losses, especially at wide scan angles with respect to a ‘boresight’ or perpendicular axis of alignment of the antenna elements of the ESA due to factors such as noise, design inefficiencies, and other factors, without the application of dielectric lens 110 thereto. To improve performance of ESA 120, dielectric lens 110 can be applied to ESA 120 to refract electromagnetic energy produced by ESA 120, affect gain achievable by ESA 120 at various scan angles, including both boresight and off-boresight angles, such as by reducing scan losses, and improving efficiency across the antenna elements of ESA 120.

In various implementations, dielectric lens 110 is representative of a shaped dielectric component applied to ESA 120. More particularly, dielectric lens 110 may be manufactured from a dielectric material (e.g., syntactic foam, cross-linked polystyrene, thermoset polystyrene, ceramic-filled 3D printing resin, among others) to include a convex domed arrangement. As shown in aspect 100, dielectric lens 110 includes a domed portion 112 with a curved surface and a base portion 114 with a flat surface that may be applied to, coupled to, mounted to, or otherwise affixed to a supporting portion of ESA 120, or a portion of a system or device including ESA 120 (e.g., a chassis, frame, bus, or vehicle). In this configuration, the antenna elements of ESA 120 are (at least partially) enclosed by and positioned within the domed portion 112, such that in operation, the antenna elements emit (or receive) electromagnetic beams with respect to selected scan angles through the domed portion of dielectric lens 110.

In various implementations, the dimensions of dielectric lens 110 are determined based on a desired target performance of an ESA over a desired target bandwidth. For example, these dimensions include height 115, height 116, length 117, and length 118, among other dimensions, such curvature. Height 115 corresponds to a total height of dielectric lens 110 from the base portion to the top of the domed portion 112 (e.g., crown, apex), height 116 corresponds to a maximum height of the space in which the ESA may be disposed, length 117 corresponds to a total length, or the diameter, of dielectric lens 110, and length 118 corresponds to a length, or the diameter, of the internal cavity portion of dielectric lens 110. The thickness of dielectric lens 110 at different locations of domed portion 112 may be determined by such dimensions of dielectric lens 110, empirically determined performance, RF performance considerations, scan angles, and other factors.

Additionally, the dielectric material and properties thereof can enhance performance of ESA 120. More specifically, the dielectric material selected for formation of dielectric lens 110 may be configured to provide impedance matching and other increased capabilities for ESA 120. In some example implementations, a dielectric material having a ‘high’ dielectric constant (Dk˜4.0 or greater) laminate impedance matching layer is selected as the material that comprises dielectric lens 110, or a portion thereof. For instance, the material can form the body of dielectric lens 110, or can instead comprise a surface layer or coating and applied to at least one surface of dielectric lens 110. When configured as a layer, this layer may be applied to an inner surface of the domed portion 112 of dielectric lens 110, the inner surface referring to the inside area of dielectric lens 110 in which ESA 120 is disposed. In another example, this layer may be applied to an outer surface of the domed portion 112 of dielectric lens 110. Other combinations and variations may be contemplated.

In operation, ESA 120 forms directed beams of RF energy for transmission (and reception) of signals via the antenna elements. Dielectric lens 110, as applied to ESA 120, can better focus the beams, increase gain of the RF energy produced by ESA 120 over a selected angular range, improve other performance at various scan angles (e.g., off-boresight angles), and enhance efficiency by establishing more uniform performance across the antenna elements of ESA 120. Accordingly, dielectric lens 110 advantageously allows ESA 120 to operate with a target performance across a wide range of scan angles, improving the gain and efficiency, among other operating characteristics, of ESA 120 and the antenna elements thereof. For a given performance level, ESA 120 can be of a smaller size, weight, power, and cost than an ESA without dielectric lens 110.

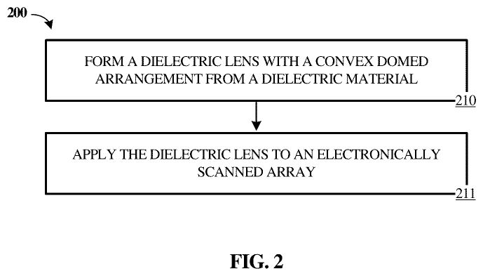

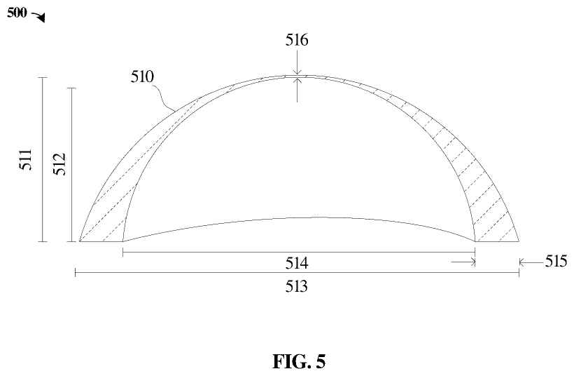

FIG. 2 illustrates a method of manufacturing an assembly including an electronically scanned array (ESA) and a dielectric lens in an implementation. FIG. 2 includes operations 200, which references elements of FIG. 1. Operations 200 may also be applicable to other ESAs and dielectric lenses, such as ones shown in FIGS. 5, 6, 7, 8, and 9, as well as other combinations and variations thereof.

To begin, in operation 210, the method includes forming dielectric lens 110 having a convex domed arrangement from a dielectric material. In various implementations, dielectric lens 110 is representative of a manufactured dielectric dome lens having a domed portion 112 and a flat base portion 114. Forming dielectric lens 110 may include forming dielectric lens 110 using syntactic foam or other low-density foam or dielectric materials with a selected dielectric constant (Dk˜2.5) for a selected frequency range. Forming dielectric lens 110 may instead include machining from a block or bulk workpiece of material. Example materials for machining techniques include cross-linked polystyrene, thermoset polystyrene, or other similar materials. Alternatively, forming dielectric lens 110 may include molding, additively manufacturing, or 3D printing dielectric lens 110 using printable dielectric materials, such as various resins, polymers, or materials having ceramic-filled UV-curable polymers. Moreover, the material can be selected based on an environment into which the corresponding assembly is to be deployed, such as space, marine, terrestrial, airborne, and other environments having various environmental properties including atmosphere, vacuum, moisture, dust, thermal gradients, solar irradiance, and other properties.

In some implementations, dielectric lens 110 includes an array of impedance matching holes periodically spaced along the domed portion of dielectric lens 110. To form the impedance matching holes, operation 210 of forming dielectric lens 110 may additionally include forming the impedance matching holes through a thickness of the dielectric material of dielectric lens 110. More specifically, this may include drilling or milling the holes into dielectric lens 110. Alternatively, this may include additive manufacturing techniques of forming holes while forming the body of dielectric lens 110. The impedance matching holes may be of various shapes and sizes, including circular, square, conical, cylindrical, and/or pyramidal shaped holes, as well as variations and combinations of shapes and sizes based on a target performance and bandwidth of ESA 120. Moreover, the depth of such holes might include penetration of the entire thickness of the body of the dielectric lens, or only a partial penetration. Properties of the holes can be tuned or parametrically determined based on target performance over selected frequency ranges, scan angles, power levels, and other performance criteria.

Next, in operation 211, the method includes applying dielectric lens 110 to ESA 120. This may entail fastening, welding, affixing, adhering, or otherwise coupling dielectric lens 120 to ESA 120, or to a surface or object on which ESA 120 is coupled, so as to cover a plurality of antenna elements of ESA 120 via the convex domed portion of dielectric lens 110.

As mentioned above, operations 200 may be applied to other dielectric lenses, such as dielectric lenses shown in FIGS. 5, 6, 7, 8, and 9 below. Operation 200 may include similar or different operations, as well as additional or fewer operations to form such dielectric lenses having various shapes, dimensions, arrangements, and the like. Additionally, operations 200 may include one or more operations for applying an absorber material to a dielectric lens and/or an ESA for cushioning, support, and reduction of reflection of electromagnetic waves, among other benefits.

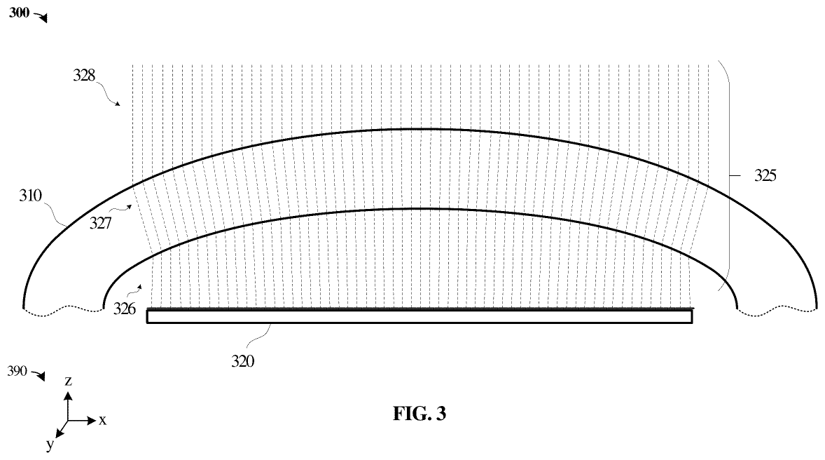

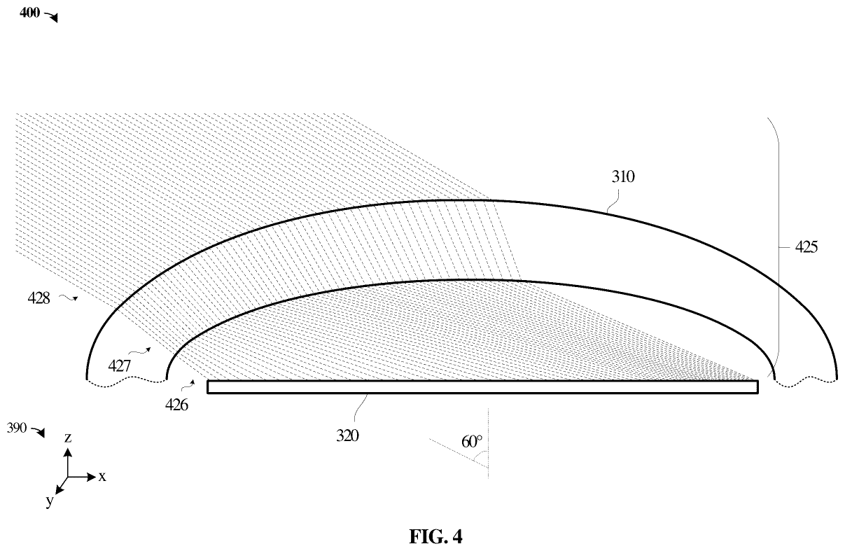

FIGS. 3 and 4 illustrate exemplary aspects of a dielectric dome lens applied to an ESA in an implementation. FIG. 3 shows aspect 300, which includes dielectric lens 310, active electronically scanned array (ESA) 320, and RF energy 325 emitted from ESA 320 at a first selected angle with respect to axes 390. FIG. 4 shows aspect 400, which includes dielectric lens 310, ESA 320, and RF energy 425 emitted from ESA 320 at a second selected angle with respect to axes 390. The first selected angle of FIG. 3 can be referred to as a boresight angle, referring to the angle generally along a longitudinal axis of ESA 320 (e.g., z-axis), or perpendicular to the planar arrangement of ESA 320. The second angle of FIG. 4 can be referred to as off-boresight, referring to the angle being skewed or tilted from the longitudinal axis of ESA 320.

Referring to both aspects 300 and 400 of FIGS. 3 and 4, respectively, ESA 320 is representative of an active phased array antenna assembly (e.g., ESA 120) including an array of antenna elements (not shown). ESA 320, using the associated antenna elements, can generate electromagnetic waves for wireless signal transmission, and can provide for reception of RF signals transmitted by other remote nodes. In a transmit mode of operation, ESA 320 can emit beams of radio frequency (RF) energy (e.g., RF energy 325, RF energy 425) from one or more antenna elements at a selected frequency range with a selected beam direction or scan angle. In a receive mode, ESA 320 can monitor for RF energy within a selected frequency range via antenna elements electronically focused in a specific direction, which can be a different direction than the transmit mode. Each of the antenna elements of ESA 320 can be electronically steered (e.g., by an RF system that provides signals having various phase or timing relationships among the antenna elements) such as to shape beams in various directions and scan angles.

In various implementations, dielectric lens 310 is representative of a shaped dielectric component (e.g., dielectric lens 110) applied to ESA 320. Dielectric lens 310 is formed from a dielectric material with a selected dielectric constant (Dk˜2.5) for a selected frequency range, as discussed herein to include a convex domed arrangement. As such, dielectric lens 310 includes a dome portion with a curved or domed surface and a base portion (omitted from view) that may be coupled to a supporting portion of ESA 320, or a portion of a system or device including ESA 320 (e.g., a panel, bus, chassis, or vehicle). In this configuration, ESA 320 is (at least partially) enclosed by and positioned within the dome portion, such that in operation, the antenna elements can emit RF beams through the dome portion of dielectric lens 310.

Now referring to aspect 300 of FIG. 3, aspect 300 shows RF energy 325 emitted by ESA 320 and one example configuration of dielectric lens 310 altering the shape and direction of RF energy 325 propagating through dielectric lens 310. RF energy 325 includes beam portions 326, 327, and 328, which correspond to segments of RF energy 325 at different locations with respect to ESA 320 and dielectric lens 310. More specifically, beam portion 326 corresponds to a segment of RF energy 325 within a space between ESA 320 and dielectric lens 310, but not within dielectric lens 310 nor in a space outside dielectric lens 310. Beam portion 327 corresponds to a segment of RF energy 325 propagating through dielectric lens 310. Beam portion 328 corresponds to a segment of RF energy 325 that has propagated through dielectric lens 310 and is now propagating in an exterior space outside of dielectric lens 310 and ESA 320.

ESA 320 emits RF energy 325 having a propagation direction in the +z direction with respect to axes 390, or, at approximately a boresight angle with respect to ESA 320. RF energy also has a beamwidth in the x-y plane, which can vary according to refraction and propagation, as discussed herein. As RF energy 325 propagates through a thickness of dielectric material of dielectric lens 310, dielectric lens 310 refracts RF energy 325 causing beam portion 327 to change propagation angle relative to the propagation direction of beam portion 326 or alter beamwidth in the x-y plane. The amount of refraction can be based on the properties of dielectric lens 310, such as a curvature, thickness, physical geometry/dimensions, the material dielectric properties, selected layering, and hole/slot configurations, among other factors. After RF energy 325 has propagated through dielectric lens 310 and exited to the space beyond dielectric lens 310, RF energy 325 can refract again to a final emitted propagation angle or beamwidth as shown by beam portion 328. The beamwidth of beam portion 328 can be expanded or reduced compared to the beamwidth of beam portions 326 or 327 in the x-y plane based on the refraction applied by dielectric lens 310. The angle of beam portion 328 can also be altered by dielectric lens 310 compared to the angle of beam portions 326 or 327. These changes in beamwidth and angle can advantageously improve the directional range, increase sensitivity, and reduce loss of ESA 320.

Referring next to aspect 400 of FIG. 4, aspect 400 shows RF energy 425 emitted by ESA 320 and one example configuration of dielectric lens 310 influencing the shape and direction of RF energy 425. RF energy 425 includes beam portions 426, 427, and 428, which correspond to segments of RF energy 425 at different locations with respect to ESA 320 and dielectric lens 310. More specifically, beam portion 426 corresponds to a segment of RF energy 425 within a space between ESA 320 and dielectric lens 310, but not within dielectric lens 310 nor in a space outside dielectric lens 310. Beam portion 427 corresponds to a segment of RF energy 425 propagating through dielectric lens 310. Beam portion 428 corresponds to a segment of RF energy 425 propagating in an exterior space outside of dielectric lens 310.

As shown in aspect 400, ESA 320 can emit RF energy 425 at an off-boresight angle (e.g., 60 degrees from the vertical +z direction) with respect to ESA 320 and axes 390. As such, beam portion 426 includes a beam shaped at an angle relative to the plane of ESA 320. As RF energy 425 propagates through a thickness of dielectric material of dielectric lens 310, dielectric lens 310 can refract RF energy 425 causing at least a subset of the RF energy 425 to change angle or beamwidth properties. The amount of refraction can be based on the properties of dielectric lens 310, such as a curvature, thickness, physical geometry/dimensions, the material dielectric properties, selected layering, and hole/slot configurations, among other factors. The beamwidth of beam portion 428 can be expanded or reduced compared to the beamwidth of beam portions 426 or 427 in the x-y plane based on the refraction applied by dielectric lens 310. The angle of beam portion 428 can also be altered by dielectric lens 310 compared to the angle of beam portions 426 or 427. These changes in beamwidth and angle can advantageously improve the directional range, increase sensitivity, and reduce loss of ESA 320.

FIGS. 5, 6, 7, 8, and 9 demonstrate various example dielectric lenses having different dimensions, geometries, and profiles designed to achieve target performance of an ESA. For example, the lens profile arrangements and dimensions can be selected to improve gain of the ESA across a range of directions, including boresight and off-boresight angles, and improve efficiency across antenna elements of the ESA such that an ESA having an asymmetrical scan area may perform beam scan operations in a balanced manner over a full scan area, among other improvements.

Additionally, dielectric materials and material properties of a dielectric lens can affect performance of a corresponding ESA. The dielectric material selected for formation of the following dielectric lenses may be configured to provide impedance matching capabilities for a given ESA. In some example implementations, a dielectric material having a ‘high’ dielectric constant (Dk˜4.0 or greater) laminate impedance matching layer is selected and applied to at least one surface of the dielectric lenses. For example, this layer may be applied to an inner surface of the dielectric lenses, the inner surface referring to the inside area of a dielectric lens in which the ESA is disposed. In another example, this layer may be applied to an outer surface of the dielectric lens. The layer may also, or instead, be applied to one or more impedance matching holes drilled into the dielectric lenses. Other combinations and variations may be contemplated.

Referring first to FIG. 5, FIG. 5 illustrates an exemplary aspect of a dielectric lens in an implementation. FIG. 5 shows aspect 500, which shows a cross-section side view of dielectric lens 510 that may be included in an assembly and applied to an electronically scanned array (ESA).

Dielectric lens 510 is representative of a shaped dielectric component that may be applied to an ESA, as another example implementation of dielectric lens 110 or dielectric lens 310 of FIGS. 1 and 3, respectively. Dielectric lens 510 may be formed from a dielectric material to include a convex domed arrangement. As such, dielectric lens 510 also includes a domed portion with a curved surface and a base portion with a flat surface that may be coupled to a supporting portion of an ESA, or a portion of a system or device including an ESA. In this arrangement, dielectric lens 510 comprises a thin crown area at angles close to boresight and thicker side portions at off-boresight and more extreme angles. An ESA may be positioned within the domed portion, such that in operation, the antenna elements emit electromagnetic beams at targets through the domed portion of dielectric lens 510.

Dielectric lens 510 includes various dimensions determined based on the target performance of an ESA over a target bandwidth, such as height 511, height 512, length 513, and length 514. Height 511 corresponds to a total height of dielectric lens 510 from the base portion to the top of the domed portion (e.g., crown, apex), height 512 corresponds to a maximum height of the space in which the ESA may be disposed, length 513 corresponds to a total length, or the diameter, of dielectric lens 510, and length 514 corresponds to a length, or the diameter, of the internal, hollowed portion of dielectric lens 510. Thickness 516 of dielectric lens 510 at the crown/apex and thickness 515 of the sidewall portions may be determined based on various factors, including performance factors, material characteristics, RF energy propagation/loss properties, ESA scan angle capability, or other factors. In one example, a thinner amount of dielectric material at apex thickness 516 can provide for less refraction and/or less alteration of RF energy for beams along a boresight angle, and a thicker amount of dielectric material at sidewall thickness 515 can provide for more refraction and/or more alteration of RF energy for beams at off-boresight angles. This can improve off-boresight scan angle performance for an ESA in some examples.

In an example implementation where dielectric lens 510 does not include impedance matching layers on or within one or more surfaces of the domed portion of dielectric lens 510, dielectric lens 510 includes height 511 of approximately 37 millimeters (mm), and length 513 of approximately 143 mm. In such an implementation, an ESA positioned within the domed portion of dielectric lens 510 may exhibit a gain of −6.0 dB at zero degrees relative to a boresight scan angle of the ESA, a gain of −6.7 dB at fifteen degrees relative to the boresight scan angle of the ESA, a gain of −6.7 dB at thirty degrees relative to the boresight scan angle of the ESA, a gain of −4.8 dB at forty-five degrees relative to the boresight scan angle of the ESA, and a gain of −4.4 dB at sixty degrees relative to the boresight scan angle of the ESA.

In another example implementation where dielectric lens 510 includes one or more impedance matching layers on or within one or more surfaces, dielectric lens 510 includes height 511 of approximately 38 millimeters (mm), and length 513 of approximately 148 mm. In such an implementation, an ESA positioned within the domed portion of dielectric lens 510 may exhibit a gain of −5.7 dB at zero degrees relative to a boresight scan angle of the ESA, a gain of −5.5 dB at fifteen degrees relative to the boresight scan angle of the ESA, a gain of −5.5 dB at thirty degrees relative to the boresight scan angle of the ESA, a gain of −4.0 dB at forty-five degrees relative to the boresight scan angle of the ESA, and a gain of −4.7 dB at sixty degrees relative to the boresight scan angle of the ESA. Other dimensions and profiles of dielectric lens 510 may be contemplated to achieve target performance (e.g., gain) of the ESA.

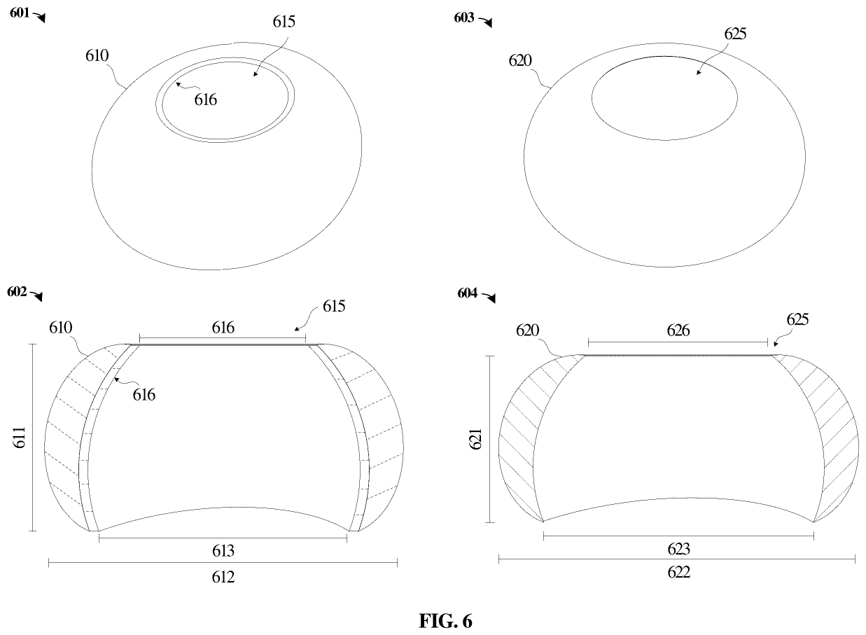

Referring next to FIG. 6, FIG. 6 shows exemplary aspects of two dielectric lens example implementations having apertures at respective crowns/apex regions. FIG. 6 includes aspects 601, 602, 603, and 604. Aspect 601 includes an isometric view of dielectric lens 610, aspect 602 includes a cross-section side view of dielectric lens 610, aspect 603 includes an isometric view of dielectric lens 620, and aspect 604 includes a cross-section side view of dielectric lens 620.

Dielectric lenses 610 and 620 are representative of shaped dielectric components applicable to ESAs, and formed from a dielectric material to include a toroidal or donut-shaped arrangement. In these arrangements, dielectric lenses 610 and 620 include thicker, rounded side portions at off-boresight scan angles and apertures 615 and 625, respectively, at boresight scan angles. An ESA may be positioned within a space enclosed by the rounded side portions. In operation of an ESA of an assembly including one of dielectric lenses 610 and 620, the antenna elements of the ESA can emit electromagnetic beams through apertures 615 or 625, respectively, at boresight scan angles, and through dielectric material of the rounded side portions of dielectric lens 610 or 620, respectively, at off-boresight scan angles.

Dielectric lenses 610 and 620 each have various dimensions that may differ from one another to provide for different performances of ESAs. For example, dielectric lens 610 includes a different diameter aperture than dielectric lens 630 based on lengths 612 and 613 relative to lengths 622 and 623, respectively. Thicknesses of the sidewall portions of dielectric lenses 610 and 620 may be determined based on various factors, including performance factors, material characteristics, RF energy propagation/loss properties, ESA scan angle capability, or other factors. In one example, the lack of dielectric material at apex apertures can provide for no refraction and/or no alteration of RF energy for beams along a boresight angle, and a thicker amount of dielectric material at sidewall thicknesses can provide for more refraction and/or more alteration of RF energy for beams at off-boresight angles. This can improve off-boresight scan angle performance for an ESA in some examples.

The aperture of dielectric lenses 610 and 620 might be centered on a symmetric centerline of the respective lens body, or may be offset from a centerline, forming a tilted ellipse or asymmetric arrangement. This asymmetric arrangement can shape RF beamforming operations or RF lobes of corresponding ESAs to provide for asymmetric performance over a range of scan angles, or to balance performance for an asymmetric ESA over a range of scan angles, among other configurations.

Dielectric lens 610 also includes impedance matching layer 616 on corresponding interior sidewalls. Impedance matching layer 616 can be included to reduce reflections or losses due to impedance mismatches among the interior space of dielectric lens 610 and the material forming dielectric lens 610. The impedance matching layer can be formed using various coatings or composite materials, including a different density of the same material used to form dielectric lens 610. Coatings include various RF transparent or refracting materials which can be painted, adhered, deposited, or otherwise applied to a desired thickness to an interior (or exterior) surface of dielectric lens 610. Differing densities of material can form a gradient or transition region having a gradual change in impedance. This can be achieved using various techniques, including 3D printing of a lattice structure or hole-filled section, or may instead be formed using syntactic foam, various closed/open cell foams, as well as machined or drilled features to reduce a density or structural configuration.

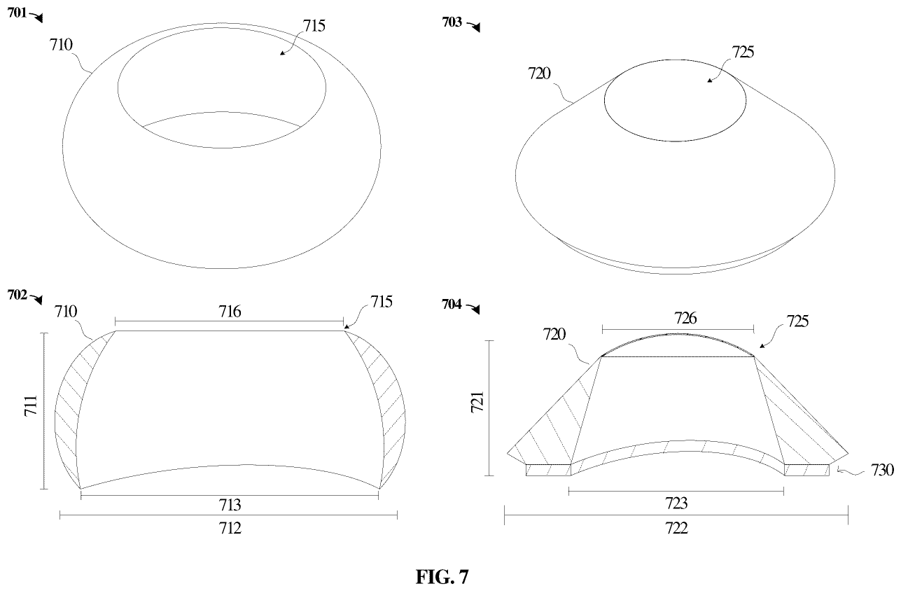

FIG. 7 also shows aspects of exemplary of dielectric lenses in example implementations having apertures at respective crowns/apex regions. FIG. 7 includes aspects 701, 702, 703, and 704. Aspect 701 includes an isometric view of dielectric lens 710, aspect 702 includes a cross-section side view of dielectric lens 710, aspect 703 includes an isometric view of dielectric lens 720, and aspect 704 includes a cross-section side view of dielectric lens 720.

Referring first to aspects 701 and 702 of FIG. 7, aspects 701 and 702 show views of dielectric lens 710, representative of a shaped dielectric component applicable to ESAs formed from a dielectric material to include a toroidal or donut-shaped arrangement similar to dielectric lenses 610 and 630 of FIG. 6. Dielectric lens can include symmetric or asymmetric configurations as discussed above in FIG. 6. Dielectric lens 710 may include a different configuration of a curved portion than dielectric lenses 610 and 630 as well as a wider aperture 715 than dielectric lenses 610 and 630. Additionally, the walls of the curved portion of dielectric lens 710 are shown as thinner than the walls of the curved portions of dielectric lenses 610 and 630. As a result of the different shape profile, dielectric lens 710 may offer a variation in performance for an ESA relative to dielectric lenses 610 and 630, among other dielectric lenses.

In an example implementation where dielectric lens 710 does not include impedance matching layers on or within one or more surfaces of the cavity portion of dielectric lens 710, dielectric lens 710 includes height 711 of approximately 64 millimeters (mm), and length 712 of approximately 144 mm. In such an implementation, an ESA positioned within the domed portion of dielectric lens 710 may exhibit a gain of −2.0 dB at zero degrees relative to a boresight scan angle of the ESA, a gain of −2.7 dB at fifteen degrees relative to the boresight scan angle of the ESA, a gain of −3.5 dB at thirty degrees relative to the boresight scan angle of the ESA, a gain of −1.1 dB at forty-five degrees relative to the boresight scan angle of the ESA, and a gain of −2.3 dB at sixty degrees relative to the boresight scan angle of the ESA.

In another example implementation where dielectric lens 710 includes one or more impedance matching layers on or within one or more surfaces, dielectric lens 710 includes height 711 of approximately 71 mm, and length 712 of approximately 160 mm. In such an implementation, an ESA positioned within the cavity portion of dielectric lens 710 may exhibit a gain of −0.4 dB at zero degrees relative to a boresight scan angle of the ESA, a gain of −1.5 dB at fifteen degrees relative to the boresight scan angle of the ESA, a gain of −4.0 dB at thirty degrees relative to the boresight scan angle of the ESA, a gain of −1.2 dB at forty-five degrees relative to the boresight scan angle of the ESA, and a gain of −0.4 dB at sixty degrees relative to the boresight scan angle of the ESA. Other dimensions and profiles of dielectric lens 710 may be contemplated to achieve target performance (e.g., gain) of the ESA.

Referring next to aspects 703 and 704 of FIG. 7, aspects 703 and 704 show dielectric lens 720, which has a dielectric material formed to include a tilted prism configuration similar to a truncated conic or rotated trapezoidal-like arrangement. In this arrangement, dielectric lens 720 includes tapered side portions and aperture 725. The tapered side portions include thicker bottom portions that thin out towards the top of dielectric lens 720 near aperture 725, although variations are possible. Accordingly, the base portion of dielectric lens 720 is wider than aperture 725 as illustrated in aspect 704 and evidenced by lengths 722 and 723 relative to length 726.

An ESA may be positioned within a space enclosed by the tapered side portions. In operation of an ESA of an assembly including dielectric lens 720, the antenna elements of the ESA can emit electromagnetic beams through aperture 725 at boresight angles, and through dielectric material of the tapered side portions of dielectric lens 720 at off-boresight angles, including combinations thereof.

In an example implementation, dielectric lens 720 includes height 721 of approximately 54 mm, and length 722 of approximately 155 mm. In such an implementation, an ESA positioned within the cavity portion of dielectric lens 720 may exhibit a gain of −1.7 dB at zero degrees relative to a boresight scan angle of the ESA, a gain of −2.0 dB at fifteen degrees relative to the boresight scan angle of the ESA, a gain of −4.0 dB at thirty degrees relative to the boresight scan angle of the ESA, a gain of −4.2 dB at forty-five degrees relative to the boresight scan angle of the ESA, and a gain of −3.5 dB at sixty degrees relative to the boresight scan angle of the ESA. Other dimensions and profiles of dielectric lens 720 may be contemplated to achieve target performance (e.g., gain) of the ESA.

Absorber material 730 is also included in the assembly shown in aspect 704 and coupled to the base portion of dielectric lens 720. In various implementations, absorber material 730 is representative of one or more elements capable of attenuation of RF energy, such as to reduce reflections and leakage effects within dielectric lens 720 and for an ESA applied thereto, and/or providing impedance matching capabilities for the ESA, among other functions. Absorber material 720 can comprise RF attenuating or RF absorbing materials, such as RF absorbing foams (e.g., polyurethane foam, polystyrene foam) with optional additives as RF absorbing materials, ferrite-loaded materials (e.g., polymer or rubber filled with ferrite particles), rubber, silicone, and the like.

Absorber material 730 may be disposed such that absorber material 730 surrounds a perimeter of an ESA within dielectric lens 720, forms a frame or border about the ESA, or has edges that rise up from the plane of the ESA to absorb side lobe portions of stray RF energy generally in-plane with the ESA. While shown as a single element in aspect 704, absorber material 730 may be formed using multiple absorber materials applied to portions of dielectric lens 720 and/or to an ESA within dielectric lens 720. Other dielectric lenses shown in the preceding and following Figures may also include absorber materials. Moreover, absorber materials can be included along with impedance matching features discussed for dielectric lens 610.

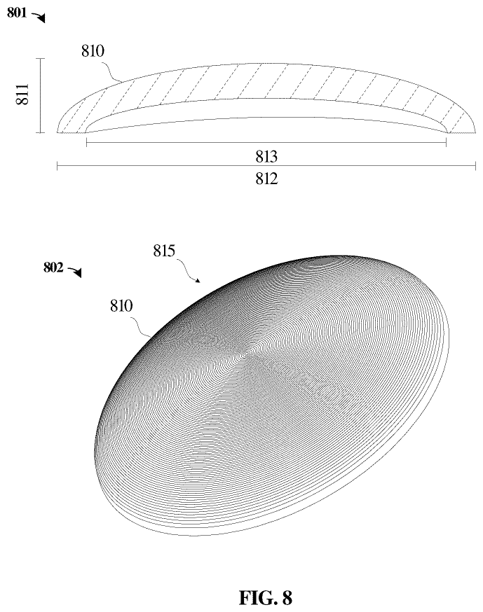

FIG. 8 shows exemplary aspects of a dielectric lens in an implementation. FIG. 8 includes aspects 801 and 802, which show a cross-section side view of dielectric lens 810, and an isometric view of dielectric lens 810 having etched or machined pattern 815.

Dielectric lens 810 is representative of a shaped dielectric component applicable to ESAs formed from a dielectric material. Aspects 801 and 802 show dielectric lens 810 as having a convex domed shape like dielectric lenses 110, 310, and 510 of FIGS. 1, 3, and 5, respectively, but with a different profile. More specifically, dielectric lens 810 includes a domed portion with a curved and etched surface and a base portion that may be coupled to a supporting portion of an ESA, or a portion of a system or device including an ESA.

Additionally, as shown in aspect 802, dielectric lens 810 includes pattern 815 on the outer surface of the curved portion of dielectric lens 810. The pattern, thickness of the etching, and the like of pattern 815 may be selected to influence performance of an ESA coupled to dielectric lens 810. Pattern 815 may be etched, machined, or additively formed, such as during 3D printing, on dielectric lens 810. Pattern 815 is shown as a series of concentric circular features, which may include circular etchings, arc segments, grooves, spirals, radial patterns, or other various configurations.

In an example implementation, dielectric lens 810 includes height 811 of approximately 25 millimeters (mm), and length 812 of approximately 150 mm. In such an implementation, an ESA positioned within the domed portion of dielectric lens 810 may exhibit a gain of −0.5 dB at zero degrees relative to a boresight scan angle of the ESA, a gain of −0.7 dB at fifteen degrees relative to the boresight scan angle of the ESA, a gain of −1.1 dB at thirty degrees relative to the boresight scan angle of the ESA, a gain of −1.6 dB at forty-five degrees relative to the boresight scan angle of the ESA, and a gain of −1.2 dB at sixty degrees relative to the boresight scan angle of the ESA. Other dimensions and profiles of dielectric lens 810 may be contemplated to achieve target performance (e.g., gain) of the ESA.

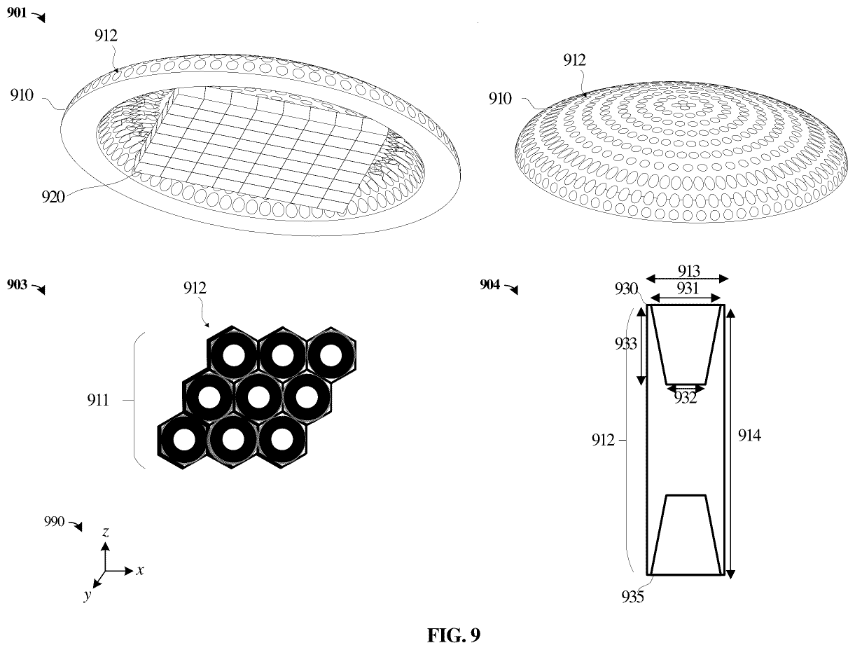

FIG. 9 shows exemplary aspects of another dielectric lens in an implementation as well as aspects of an array of holes formed at least partially through the dielectric lens material. FIG. 9 includes aspects 901, 902, 903, and 904. Aspects 901 and 902 include isometric views of dielectric lens 910, while aspect 903 includes a view of a subset of holes of dielectric lens 910. Aspect 904 shows a cross-section side view of one example implementation of an individual hole of dielectric lens 910.

Dielectric lens 910 is representative of a shaped dielectric component applicable to ESAs formed from a dielectric material. Aspects 901 and 902 show dielectric lens 910 as having a convex domed shape, which can be similar to dielectric lenses 110, 310, 510, and 810 of FIGS. 1, 3, 5, and 8 respectively, although variations are possible. Aspect 901 also shows dielectric lens 910 as applied to electronically scanned array (ESA) 920.

In various implementations, ESA 920 is representative of a phased array antenna assembly including a plurality of antenna elements for wireless RF transmission and reception. Each of the antenna elements of ESA 920 can be electronically steered (e.g., by an RF system that provides selectively phased/timed signals to/from the antenna elements) such as to shape the beams produced by the antenna elements in various directions and beamwidths across associated frequency ranges.

To improve operational performance of ESA 920, dielectric lens 910 is applied to ESA 920 to refract electromagnetic energy produced by ESA 920, affect gain achievable by ESA 920 at various scan angles, including both boresight and off-boresight angles, such as by reducing scan losses, and improve efficiency across the antenna elements of ESA 920.

In various implementations, as shown by aspects 901 and 902, dielectric lens 910 also includes an array of holes formed at least partially through a thickness of the domed portion of the dielectric material of dielectric lens 910. An example of one of these holes is labeled as hole 912. Each hole may include shaped or tapered ends formed on both surfaces of dielectric lens 910, which are shown and described in more detail below with respect to aspect 904. Inside each hole, the ends can abut a penetrating hole. The properties of the holes, including various hole diameters, and the quantity of the holes can be determined based on a target performance of ESA 920 over a target bandwidth with respect to beam scan operations across a directional range.

Aspect 903 includes a subset 911 of holes of dielectric lens 910. Each of the holes of subset 911, such as hole 912, as well as other holes of dielectric lens 910 may be drilled, milled, molded, cast, machined, additively formed during formation of the dome, or otherwise formed or manufactured. As shown in aspect 903, the holes are arranged in a hexagonal pattern such that each hole is positioned equidistant from one another, and such that the holes are distributed evenly among the domed portion of dielectric lens 910. Other positioning, patterns, and dimensions of the holes may be employed.

An exemplary internal, cross-section view of hole 912 is shown in aspect 904 of FIG. 9. Hole 912 includes tapered ends 930 and 935, which abut a cylindrical hole inside hole 912 between inner end portions of tapered ends 930 and 935. Hole 912 has a hole width 913 and a hole length 914. Hole length 914 may correspond to the thickness of the dielectric material of dielectric lens 910. Tapered end 930 is formed within a portion of hole 910 and has an outer diameter 931, an inner diameter 932, and a depth 933. Outer diameter 931 may be smaller than hole width 913, and inner diameter 932 may be smaller than outer diameter 931 due to the tapered shape of tapered end 930. Tapered end 935 includes the same features and dimensions as tapered end 930, so a related discussion is omitted herein for the sake of brevity. It follows that as tapered ends 930 and 935 extend inward (i.e., in the-z direction, and in the +z direction, respectively, with respect to axes 990) into hole 912, the diameter of tapered ends 930 and 935 shrinks.

Each hole of a dielectric lens may include the same features (e.g., tapered ends) and dimensions as hole 912, although variations in shape, size, spacing, and cross-section over the extent of the dielectric lens are possible. In operation, the array of holes can provide impedance matching features and/or lower an effective dielectric constant of the material of the dielectric lens. Other features and functionality provided by holes include wide band impedance matching, reduction of adhesive delamination for layers of the dielectric lens, and reduction of the mass of the dielectric lens, among other features. Additionally, each hole, including hole 912, may be coated with a selected dielectric constant material to improve impedance matching between portions of electromagnetic beams propagated from an ESA from one free space through a dielectric lens to another free space. Thus, as electromagnetic beams pass through hole 912 from end to another, such as in through tapered end 930 and out through tapered end 935, hole 912 may reduce reflections and absorb losses in the propagation of the electromagnetic beams produced by an ESA.

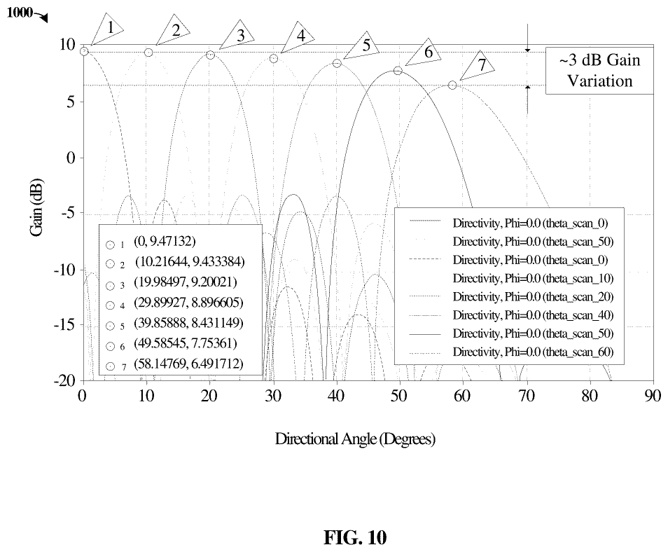

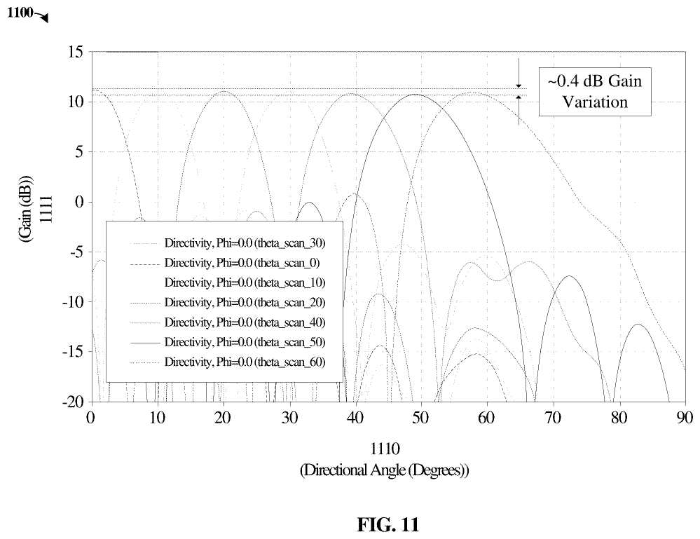

FIGS. 10 and 11 illustrate exemplary graphical representations of ESA performance in an implementation. In particular, FIG. 10 shows graphical representation 1000, which includes various waveforms corresponding to operating performance of one or more antenna elements of an ESA with respect to gain (vertical axis) and directional angle (horizontal axis) without the application of a dielectric lens discussed herein, and FIG. 11 shows graphical representation 1100, which includes various waveforms corresponding to operating performance of one or more antenna elements of an ESA with respect to gain (vertical axis) and directional angle (horizontal axis) when a dielectric lens discussed herein is applied thereto.

Referring first to graphical representation 1000 of FIG. 10, graphical representation 1000 includes various waveforms, each waveform corresponding to a set of electromagnetic beams emitted by an ESA at a different angle relative to a surface of the ESA, ranging from boresight angles to off-boresight angles. As shown in graphical representation 1000, the waveforms corresponding to off-boresight angles, illustrated by higher values with respect to directional angle, suffer from scan losses. As a result of scan losses, the ESA performance is reduced, illustrated by a decline in value with respect to gain across increasing values with respect to directional angle.

Referring next to graphical representation 1100 of FIG. 11, graphical representation 1100 also includes various waveforms, each corresponding to a set of electromagnetic beams emitted by an ESA at a different angle relative to a surface of the ESA, ranging from boresight angles to off-boresight angles. However, at least a portion of the electromagnetic beams pass through a dielectric lens (e.g., any of the various dielectric lens examples discussed herein). Unlike the waveforms shown in graphical representation 1000, the waveforms shown in graphical representation 1100 remain relatively constant (within ˜0.4 dB gain) even at off-boresight angles as the dielectric lens reduces scan losses and minimizes variations in values with respect to gain across values with respect to directional angle.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The various materials and manufacturing processes discussed herein are employed according to the descriptions above. However, it should be understood that the disclosures and enhancements herein are not limited to these materials and manufacturing processes and can be applicable across a range of suitable materials and manufacturing processes. Thus, the descriptions and figures included herein depict specific implementations to teach those skilled in the art how to make and use the best options. For the purpose of teaching inventive principles, some conventional aspects have been simplified or omitted. Those skilled in the art will appreciate variations from these implementations that fall within the scope of this disclosure. Those skilled in the art will also appreciate that the features described above can be combined in various ways to form multiple implementations.

What is claimed is:

1. An apparatus comprising:
an electronically scanned array; and
a dielectric lens applied to the electronically scanned array;
wherein the dielectric lens comprises a domed arrangement formed from dielectric material.

2. The apparatus of claim 1, wherein the dielectric lens is applied over the electronically scanned array such that beam scan operations across a directional range achieve a target performance over a target bandwidth.

3. The apparatus of claim 2, wherein the directional range includes off-boresight angles.

4. The apparatus of claim 1, wherein the dielectric material is configured to provide impedance matching over a selected frequency range.

5. The apparatus of claim 1, wherein the dielectric lens comprises the dielectric material having a pattern of holes formed therein.

6. The apparatus of claim 1, wherein the dielectric lens comprises an aperture centered on a centerline of a body of the dielectric lens.

7. The apparatus of claim 1, wherein the dielectric lens comprises an aperture offset from a centerline of a body of the dielectric lens such that the domed arrangement comprises an asymmetric arrangement.

8. The apparatus of claim 1, wherein the dielectric lens comprises the dielectric material having a selected dielectric constant laminate impedance matching layer applied to at least one surface.

9. The apparatus of claim 1, wherein the dielectric material is selected from at least one among syntactic foam, cross-linked polystyrene, thermoset polystyrene, and ceramic-filled 3D printing resin.

10. The apparatus of claim 1, further comprising absorber materials positioned in parallel with the electronically scanned array and disposed between one or more outer edges of the electronically scanned array and the dielectric lens.

11. A dielectric lens comprising:
dielectric material; and
a domed arrangement formed from the dielectric material;
wherein the dielectric material is configured to provide impedance matching for an electronically scanned array such that beam scan operations performed by the electronically scanned array across a directional range achieve a target performance over a target bandwidth.

12. The dielectric lens of claim 11, wherein the directional range includes off-boresight angles.

13. The dielectric lens of claim 11, wherein the dielectric material comprises a pattern of holes formed therein.

14. The dielectric lens of claim 11, wherein the dielectric lens comprises an aperture offset from a centerline of the dielectric lens such that the domed arrangement comprises an asymmetric arrangement.

15. The dielectric lens of claim 11, wherein the dielectric lens comprises the dielectric material having a selected dielectric constant laminate impedance matching layer applied to at least one surface.

16. The dielectric lens of claim 11, wherein the dielectric material is selected from at least one among syntactic foam, cross-linked polystyrene, thermoset polystyrene, and ceramic-filled 3D printing resin.

17. A method, comprising:
forming, from a dielectric material, a dielectric lens with a domed arrangement; and
applying the dielectric lens to an electronically scanned array.

18. The method of claim 17, wherein forming the dielectric lens comprises forming the dielectric lens with a pattern of holes through a thickness of the dielectric lens, wherein each of the holes comprises tapered ends abutting a penetrated hole through the dielectric material.

19. The method of claim 17, wherein forming the dielectric lens comprises applying a selected dielectric constant laminate impedance matching layer to at least one surface of the dielectric lens.

20. The method of claim 17, wherein the dielectric material is selected from at least one among syntactic foam, cross-linked polystyrene, thermoset polystyrene, and ceramic-filled 3D printing resin.
